(19) United States
(12) Patent Application Publication
(10) Pub. No.: US 2023/0192523 A1
(43) Pub. Date: Jun. 22, 2023

(54) ALGAE PREVENTIVE DEVICE

(71) Applicant: Mark Domjancic, Grimsby (CA)

(72) Inventor: Mark Domjancic, Grimsby (CA)

(21) Appl. No.: 18/083,505

(22) Filed: Dec. 17, 2022

Related U.S. Application Data
(60) Provisional application No. 63/291,341, filed on Dec. 17, 2021.

(51) Int. Cl. C02F 9/20; E04H 4/12; A01K 63/04

(52) U.S. Cl. CPC C02F 9/20; E04H 4/1209; A01K 63/045; C02F 1/001

(57) ABSTRACT

An algae preventive device for prevention of algae buildup in an aquarium is presented. The algae preventive device is useful for eliminating algae growth on all surfaces. Also, the algae preventive device is useful for keeping water clear and can be used on ponds, pools and aquariums. The algae preventive device does not impact fish or plant life and does not require testing of water, high-grade filers and media, lighting modification or chemicals.

### PRIORITY

This utility application claims the benefit of U.S. Provisional Patent Application No. 63/291,341, filed on Dec. 17, 2021, the entirety is hereby incorporated by reference.

### FIELD OF THE INVENTION

This invention relates to aquariums. More particularly, it relates to preventing build-up of algae in aquariums, pools, and ponds.

### BACKGROUND

Algae is an informal term for a large and diverse group of photosynthetic eukaryotic organisms. These organisms can be beneficial to, or harmful to the ecology surrounding them. A harmful algal bloom (HAB) contains organisms that can severely lower oxygen levels in natural waters, killing organisms in marine or fresh waters. Some HABs are associated with algae-produced toxins.

Cyanotoxins are toxins produced by blue-green algae. Cyanobacteria are found almost everywhere, but particularly in lakes and in the ocean where, under high concentration of phosphorus conditions, they reproduce exponentially to form blooms. Blooming cyanobacteria can produce cyanotoxins in such concentrations that they poison and even kill animals and humans. Blooms can last from a few days to many months. After the bloom dies, the microbes that decompose the dead algae use up even more of the oxygen generating a “dead zone”, which can cause fish die-offs. When these zones of depleted oxygen cover a large area for an extended period of time, neither fish nor plants are able to survive.

Although a number of algaecides have been effective in killing algae, they have been used mostly in small bodies of water however, adding algaecides such as silver nitrate or copper sulfate can have worse effects, such as killing fish outright and harming other wildlife. The negative effects can therefore be worse than letting the algae die off naturally. Unlike other algaecides Zinc, in its raw form is proven to kill a large number of algae with limited or no damage to other marine and land animals. Zinc is used today in the form of strips that dissolve when precipitation strikes it. Zinc has been proven efficient for outdoor use, but the methods of delivery make it impractical for indoor use.

Keeping fish in an aquarium is a never-ending task, requiring one to constantly clean, feed and maintain the tank for the benefit of the fish. One important facet of this care is keeping the inside of the tank free from algae. Many people rely on a complicated regimen that uses water testing, high-grade filters and media, lighting modifications, chemicals, and even physical re1noval of the algae. All of this of course takes time and money and may be dangerous or negatively impact the fish or plant life contained within the aquarium. On a larger scale, algae can also be a problem in pools and ponds as well, where the larger volume of water requires even more time and resources to battle.

Accordingly, and in light of the foregoing, there exists a need for a device by which algae can be eliminated from aquariums, pools and ponds without the disadvantages as described above.

### BRIEF DESCRIPTION OF THE DRAWINGS

FIG. 1 is an illustrated view of an algae preventive device.

FIG. 2 is an illustrated view of a filtering system fitted with the algae preventive device shown in FIG. 1.

FIG. 3 is an illustrated external view of an external a filtering system fitted with the algae preventive device shown in FIG. 2.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

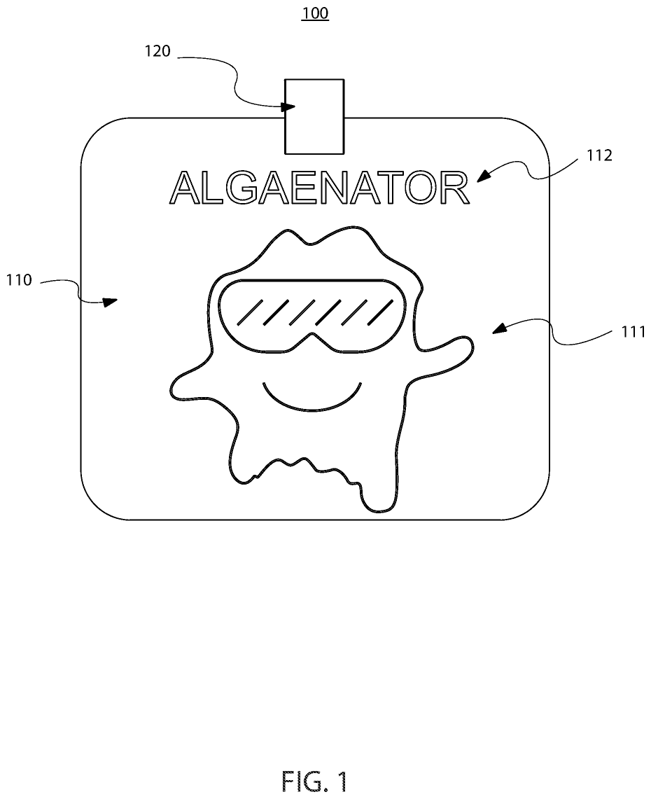

Referring to FIG. 1, an algae preventive device 100 for prevention of algae buildup in an aquarium is presented. The algae preventive device is useful for eliminating algae growth on all surfaces. Also, the algae preventive device is useful for keeping water clear and can be used on ponds, pools and aquariums. The algae preventive device does not impact fish or plant life and does not require testing of water, high-grade filers and media, lighting modification or chemicals.

The algae preventive device 100 has a body 110 and a clip 120. The body 110 of the algae preventive device 100 is preferably made of a zinc material, however other materials are hereby contemplated such as coal, paper, etc. The clip 120 of algae preventive device 100 allows the algae preventive device 100 to attach to another object, not shown, to prevent the movement of the algae preventive device 100.

The body 110 of the algae preventive device 100 has a FIG. 111 and a title 112. The FIG. 111, as shown, of the body 110 has a picture of a logo. The body 110 of the algae preventive device 100 has a title 112 where the title 112, shown in the FIG. 1 is the word “Algaenator”.

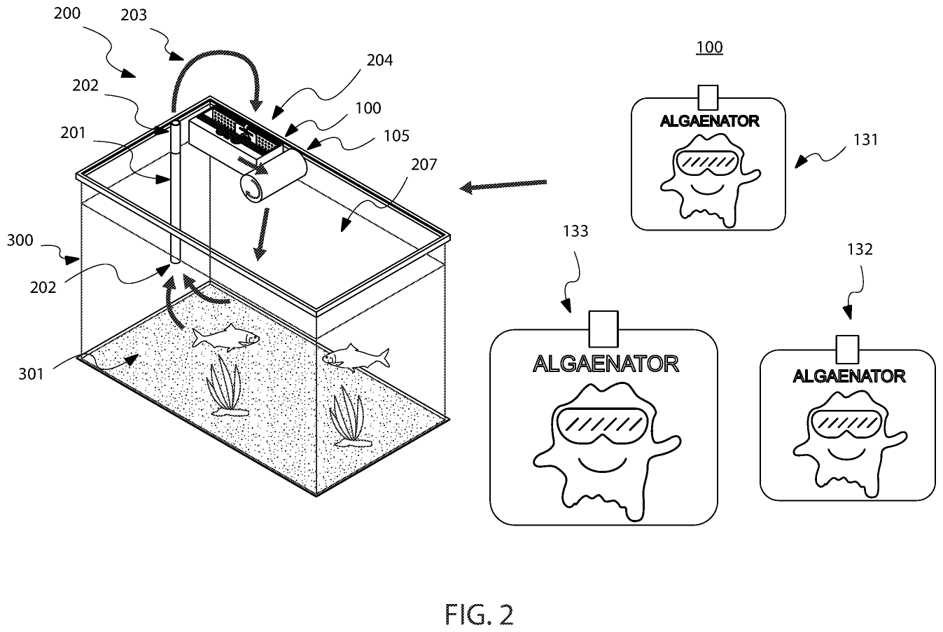

Moving now to FIG. 2, an illustrated view of a filtering system 200 fitted with the algae preventive device 100, shown in FIG. 1, is presented.

The filtering system 200 has an intake piping, where a first end 100 of the intake piping takes 202 in water 301 from an aquarium 300. A second end 202 of the intake piping 202 provides the intaking water 203 to a mechanical filtration filter 204. After passing through the mechanical filtration 204, then the water 202 is passed through a chemical filtration 205. The water 202 then passes through a biological filtration medium 206 and then outflows back into the aquarium 300.

The algae preventive device 100 is coupled to between the mechanical filtration filter 204 and the chemical filtration 205 filter by the clip 102. The zinc attracts any algae or pre-algae material and removes the algae from returning in any form back into the aquarium 300. Thus, the aquarium 300 remains algae free.

The algae preventive device 100 may come in a first small size 131, a second medium size 132 and a third large size 133. The first small size 131 is smaller in size and capacity than the second medium size 132 and the third large size 133. The second medium size 132 is larger in size and capacity than the first small size 131 but the second medium size 132 is smaller in size and capacity than the third large size 133. The third large size 133 is larger in size and capacity than the first small size 131 and the second medium size 132. The first small size 131 is preferably for aquariums, etc. The second medium size 132 is preferably for ponds, etc. The third large size 133 is preferably for pools, etc.

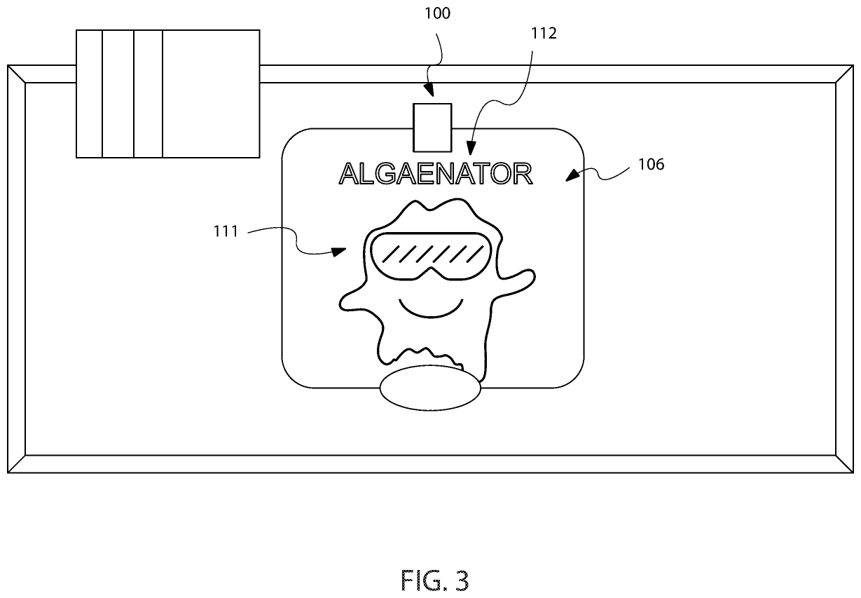

Now referring to FIG. 3, the algae preventive device is shown from an external viewpoint after being coupled to the filtration system.

A front 106 of the algae preventive device 100 is a character 111 with terminator glasses with the words “Algaenator” 112 above the character.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An algae preventive device for eliminating algae from an aquarium, pond or pool, the device comprising:
a body;
a clip, the clip coupled to a bottom of the body, wherein the clip couples the body to a filter system.

2. The device of claim 1, wherein the body having an image.

3. The device according to claim 2, wherein the body having an algae character.

4. The device of claim 3, wherein the body having a word above the algae character.

5. The device of claim 4, wherein the word is “Algaenator”.

6. The device according to claim 1, wherein the body being made of a zinc material.

7. The device according to claim 1, wherein the body being made of a coal material.

8. The device according to claim 1, wherein the body being made of a paper material.

9. The device according to claim 1, wherein the filter system comprises:
intake piping, where a first end of the intake piping takes in water from an aquarium.

10. The device according to claim 9, wherein the intake piping has a second end, the second end of the intake piping provides the intaking water to a mechanical filtration filter.

11. The device according to claim 10, wherein after passing through the mechanical filtration, then the water is passed through a chemical filtration.

12. The device according to claim 11, wherein after the water passes through the chemical filtration then the water passes through a biological filtration medium.

13. The device according to claim 12, wherein after the water passes through the biological filtration medium, the water outflows back into the aquarium.

14. The device according to claim 1, wherein the device is a first small size, a second medium size and a third large size.

15. The device according to claim 14, wherein the first small size is smaller in size and capacity than the second medium size and the third large size

16. The device according to claim 14, wherein the second medium size is larger in size and capacity than the first small size, and wherein the second medium size is smaller in size and capacity than the third large size.

17. The device according to claim 14, wherein the third large size is larger in size and capacity than the first small size and the second medium size.

18. The device according to claim 14, wherein the first small size is sized for aquariums.

19. The device according to claim 14, wherein the second medium size is sized for ponds.

20. The device according to claim 14, wherein the third large size is sized for pools.
